(19) United States
(12) Patent Application Publication
(10) Pub. No.: US 2024/0394399 A1
(43) Pub. Date: Nov. 28, 2024

(54) ENCRYPTION SYSTEM UTILIZING COMBINED TRANSFORM AND DISTRIBUTION ENCRYPTION METHODS

(71) Applicant: Michael Meadway, Bremerton, WA (US)

(72) Inventor: Michael Meadway, Bremerton, WA (US)

(21) Appl. No.: 18/200,378

(22) Filed: May 22, 2023

(51) Int. Cl. G06F 21/62; G06F 21/60

(52) U.S. Cl. CPC G06F 21/6227; G06F 21/602

(57) ABSTRACT

A combined transformation and distribution encryption method for processing data in a series of databases across a set of devices having a defined interface, each device containing a transformed subset of original object data, and each object having a unique identifier and an encryption key, comprising the steps of transforming the object via an algorithm; fragmenting each object into a plurality of subsets; separating the transformed object subsets according to an encryption algorithm; and storing each such transformed subset in a specific device and in a selected sequence based on the encryption key.

An encryption system utilizes combined transform and distribution encryption methods where stored objects are separated into fragments, the fragments arranged according to a permutation defined by an encryption key that represents a very large integer, and the fragments stored in one or more databases on a network. Successful retrieval of objects requires an object identifier and the correct permutation of fragments. Additional components include a facility for searching and sharing the content of encrypted objects.

### TECHNICAL FIELD OF THE INVENTION

The present invention relates generally to data distributed within a network and more particularly to a method and system for encrypting, cataloging, and retrieving files distributed across devices in a network.

### BACKGROUND OF INVENTION

Traditional encrypted storage relies on a series of data transformations which reversibly increase entropy in a message. Reversing that entropy without encryption keys requires enormous amounts of computing time, creating what is known as a “trapdoor” function. The most popular types of encryption current rely on the difficulty of processing very large numbers; it is possible to determine the original content given enough computing power (such as using a quantum computing system), poorly structured encryption algorithms, or improperly generated encryption keys. The threat is further increased by new discoveries in the characteristics of numbers which are at the core of current public key cryptography systems.

Encryption methods are typically described as transform or distribution methods, where a distribution method rearranges the original data in such a way to obscure its content, while a transform method alters the data according to a key value applied through an algorithm to the original data. In most encryption implementations, a transform method is used due to its applicability to both temporary data (such as network packets) and encrypted file storage. However, transform methods are unable to take advantage of distributed computing which provides far stronger encryption while encompassing all aspects of managing the storage, retrieval and cataloging of encrypted objects. The encryption technology described here is able to use these advantages while reducing the chances of inadvertent disclosure of data, a problem which has plagued organizations that use cloud (distributed) storage systems, leading to massive financial losses and damage to individuals.

In contrast, the encryption technology described in this document is a combined transform and distribution encryption method which uses a series of databases potentially distributed across many devices, each device containing a transformed subset (“slice”) of the original object data. Objects, typically files, are stored within this system such that each object has a unique identifier within the system and an encryption key, and each object is broken into some number of slices prior to storage. When an object is received by the system, it is first transformed by an algorithm to increase entropy, eliminating the appearance of any detectable pattern in the original data. Once transformed, the object is separated into slices, and each slice is stored on a specific device based on the encryption key. To retrieve data stored within the system, the unique identifier and encryption key must be provided in a request sent to a well-defined interface to the set of devices which store a desired object.

The encryption keys consist of extremely large integers which represent a permutation of the original data. A slice of the original data contains every Nth byte of the original data, where N is the number of slices to be permuted. Once a slice is created, it is then stored on a specific device based on a permuted list of N devices. The key values themselves do not have any specific characteristics (they are not prime numbers or some other particular subset of the set of integers) aside from enumerating a specific permutation out of the available permutations. However, unique to this encryption method, the range of the key values can be variable, and the strength of the range is indicated by a “degree”. A preferred implementation of the encryption would use a 256-degree system at minimum, which is nearly unbreakable through brute-force or guessing methods as the set of possible key values is approximately 8.578177753×10⁵⁰⁶ in size.

A unique feature of the described system is the ability to catalog and describe encrypted data stored in the cloud system using a faceted search engine. Facets describe content using a series of name-value pairs, where both the name and value themselves can be encrypted and where value change history is retained (versioning). Search results can be filtered or altered based on the same concept of rules and roles mentioned previously. Using the facets, it is also possible to define subsets of stored files that may be shared between organizations without divulging content or exposing the existence of other files stored in the system, thus creating a content sharing system that guarantees privacy to all parties while still permitting data sharing.

The described encryption method is also an ideal solution to the problem of storing large amounts of data within a distributed ledger system such as blockchain implementations. Typically, the blockchain ledger is composed of very small transaction records, making it impractical to store documents or media files within the system. This requires the use of a secondary storage system which may or may not be secure. Not only does the described encryption system solve the secure storage problem, but the faceting system allows for the storage of immutable data such as hash values or other information used to verify the authenticity of stored files.

### SUMMARY OF INVENTION

The present invention encrypts an object by separating it into a series of fragments, called “slices”, each of which contains a subset of the original data, where slices are extracted from the original object data in a particular order, defined by an encryption key which is a very large integer representing one permutation out of a set of N permutations. Each fragment is stored in a database, where the database selected is also defined by an encryption key. To retrieve the stored object, the identifier for the object is supplied along with one or more keys. The slices are then retrieved from their respective databases according to a key and reassembled according to a key. Finally, the reconstituted slices are recombined into an object according to the keys and sent to the requester. The core concept of the system is the rearrangement of source data into distributed slices that must be recombined in the correct order (given by the key) to be decrypted.

According to another aspect of the preferred embodiment, each object stored is assigned a unique identifier, and at least one encryption key. The unique identifier is used by a requester to retrieve a specific object, and it is used by the databases to identify slices of the data from an object.

According to another aspect of the invention, objects to be stored are pre-processed by a data transform function which diffuses bits in the original data in such a way that no pattern may be observed within the encoded data. Once the transform function is performed, the data is separated into slices and stored in databases according to the permutation indicated by the key.

According to a further aspect of the invention, slices are extracted from the object to be stored using a data selection function which uses a predictable pattern to indicate which source data is to be stored in a given slice database. The form of the data selection function is variable.

According to another aspect of the invention, slices may be further processed by a transform function, and then they are stored in slice databases along with the unique identifier.

According to a further aspect of the invention, retrieval is performed by using the unique identifier for the object stored to retrieve the correct slices from slice databases, optionally pre-processing slice data with the reverse of a previous transform function, and then using the encryption key (the permutation number) to correctly re-assemble the slices into the original order to form the object. Once re-assembled, the object may have the reverse of a previous pre-storage transform function performed, after which the object has been restored.

According to another aspect of the invention, transform and transposition function components and inputs may be distributed across many machines. This can be used to provide specific entry points for storage and retrieval operations (possibly determined by the encryption key) and provide for mechanisms such as time locks or other special rules that govern access to the stored objects.

### DESCRIPTION OF DRAWINGS

FIG. 1 is an example of how source object data is distributed to slices in a preferred embodiment with the use of an encryption key

FIG. 2 describes the data flow of the encryption process using a serial storage methodology according to various embodiments within.

FIG. 3 describes the data flow of the encryption process using a parallel storage methodology according to various embodiments within.

FIG. 4 describes the data flow of the decryption process using a serial storage methodology according to various embodiments within.

FIG. 5 describes the data flow of the decryption process using a parallel storage methodology according to various embodiments within.

FIG. 6 describes the encoding slice data using reverse index lookups according to various embodiments within.

FIG. 7 describes the example message routes (determined by key) according to various embodiments within.

### DETAILED DESCRIPTION OF INVENTION

The terminology used herein is for the purpose of describing particular embodiments only and is not intended to be limiting of the invention. As used herein, the term “and/or” includes any and all combinations of one or more of the associated listed items. As used herein, the singular forms ‘a’, ‘an’, and ‘the’ are intended to include the plural forms as well as the singular forms, unless the context clearly indicates otherwise.

It will be further understood that the terms ‘comprises’ and/or ‘comprising’ when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below. The present invention will now be described by referencing the appended figures representing preferred embodiments.

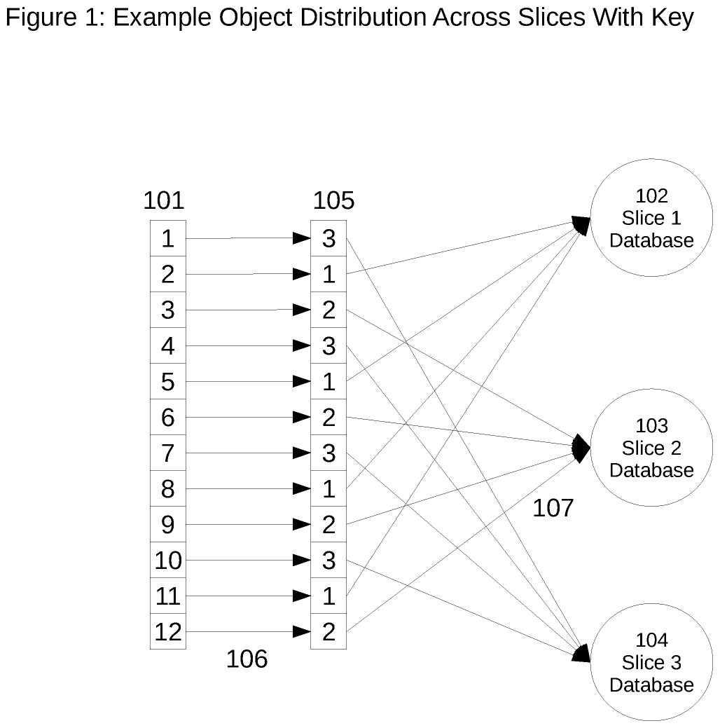

FIG. 1 is used to illustrate an example of the fundamental transposition of object data into slice databases as described in the invention summary. In preferred embodiments, the original object data 101 is arranged in a list of elements, where each element represents some fragment of the original object data, such as bytes (8-bit elements). Given a slice factor of three as shown in the figure, hereafter referred to as the variable “N”, the original source data elements are separated into three-element selections such that every Nth element of the list is transmitted via message to a slice database. According to the preferred embodiment, the object data 101 is stored in a slice database according to a value found in the key lookup table 105. In a preferred embodiment, the key lookup table 105 consists of a sequence of values referencing slice databases, and the encryption key itself is the permutation number of the sequence of values. Thus, the value “12” in the original data 101 uses the value of “2” in the key lookup table 105 to store the original data element in slice 2 database 103 via pointer 107. As described previously, this example has a slice factor of three, therefore the key value list 105 consists of three elements repeated as many times as required to store the original data 101. Thus, the second element of the key value list 105 contains a value of “1”, which references slice 1 database 102, and the third element of the key value list 105 contains a value of “2”, which references slice 2 database 103.

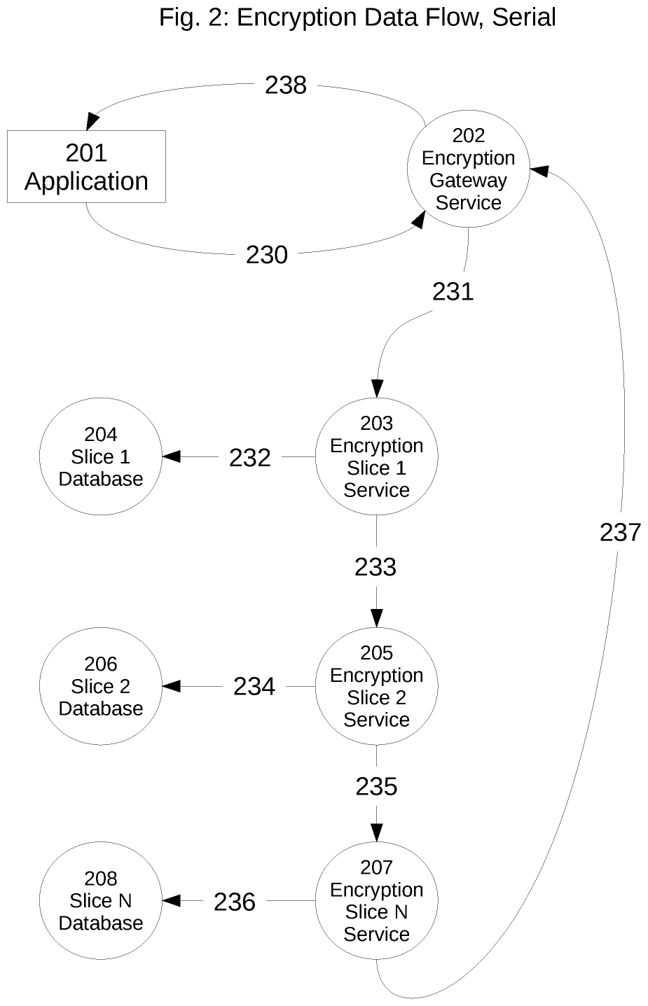

FIG. 2 is an example of the of an embodiment of the invention performing the encryption function utilizing a serial (sequential) method of data movement. In the embodiment illustrated, an application 201 transmits a combined object, object identifier and encryption key 230 to an encryption gateway service 202. The encryption gateway service 202 utilizes the key to permute the list of available encryption slice services (203,205,207), transmitting the object data to each encryption slice service according to the list of numbers in the permuted list. In the illustrated embodiment, the key has been permuted such that the slices are in the same order as the database numbering. The encryption gateway services 202 transmits the combined permuted list and object data to the first encryption slice service referenced in the permuted list. Thus, encryption slice 1 service 203 extracts every Nth element of data from the received object data where N is the number of slices, storing this data 232 into the slice 1 database 204. Subsequently, the original object data and permuted list are transmitted 233 to the next encryption slice service, encryption slice 2 service 205. As with the first encryption slice service 203, encryption slice 2 service 205 extracts every Nth element of data from the received object data, storing this data 234 into the slice 1 database 206. Finally, the original object data and permuted list are transmitted 235 to the next encryption slice service, encryption slice 3 service 207. As with the first encryption slice service 203, encryption slice 3 service 207 extracts every Nth element of data from the received object data, storing this data 236 into the slice 1 database 208. Upon completion of the storage of the object data by the final encryption slice service 207, a status message 237 indicating storage and any other metadata is transmitted to the encryption gateway services 202, which then also transmits a status message 238 to the application 201 to complete the operation.

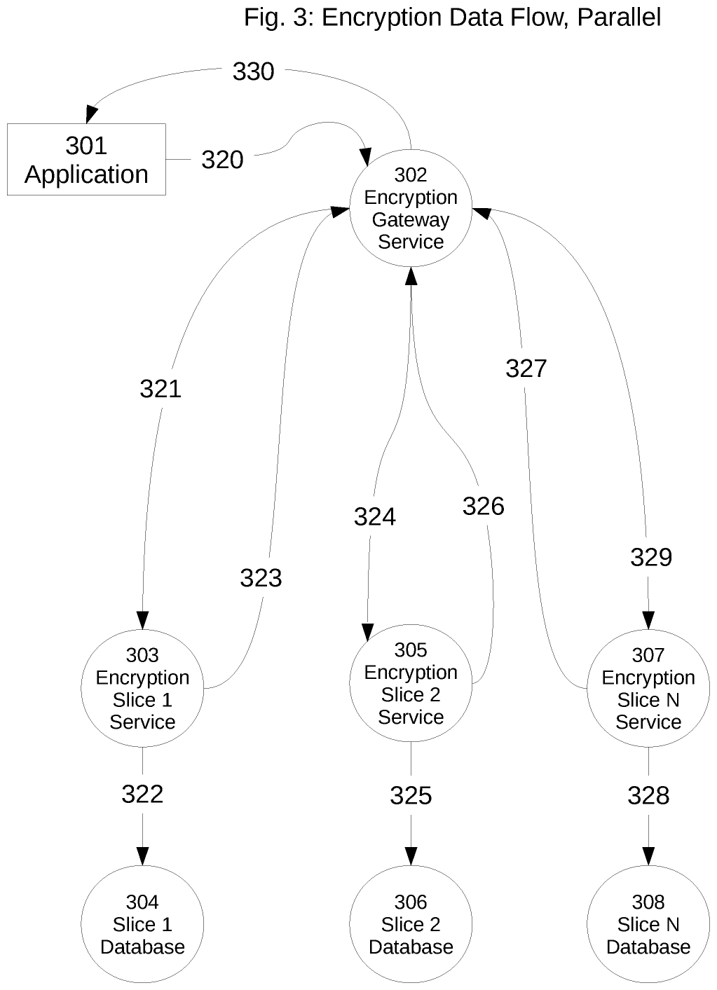

FIG. 3 is an example of the of an embodiment of the invention performing the encryption function utilizing a parallel method of data movement. In the embodiment illustrated, an application 301 transmits the original object data, object identifier and encryption key 320 to an encryption gateway service 302. The encryption gateway service 202 utilizes the key to permute the list of available encryption slice services (303,305,307), transmitting the object data to each encryption slice service according to the list of numbers in the permuted list. In the illustrated embodiment, the key has been permuted such that the slices are in the same order as the database numbering. The encryption gateway services 302 transmits the combined permuted list and every Nth element of the original object data simultaneously to all encryption slice services (303,305,307) via messages 321,324,329. Each encryption slice service (303,305,307) then stores the slice (322,325,328) into its respective database (304,306,308). Each encryption slice service (303,305,307) then responds with a status message (323,326,327) which is transmitted to the encryption gateway service 302. The encryption gateway services 302 then responds by transmitting a status message 320 to the application 301.

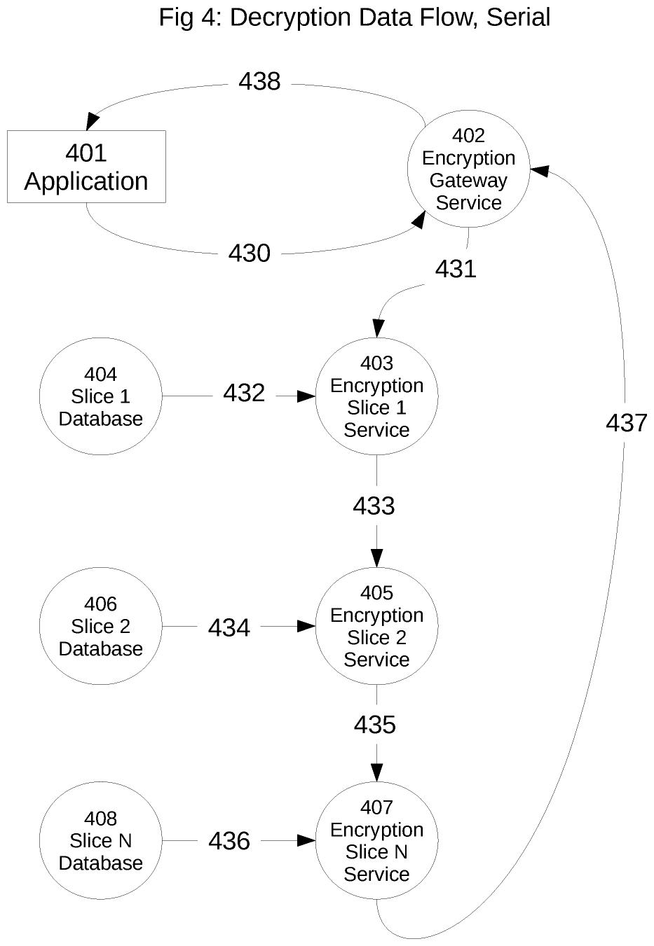

FIG. 4 is an example of the of an embodiment of the invention performing the decryption function utilizing a serial (sequential) method of data movement. In the embodiment illustrated, an application 401 transmits a combined object identifier and encryption key 430 to an encryption gateway service 402. The encryption gateway service 402 utilizes the key to permute the list of available encryption slice services (403,405,407), requesting the object data from each encryption slice service according to the list of numbers in the permuted list. In the illustrated embodiment, the key has been permuted such that the slices are in the same order as the database numbering. The encryption gateway service 402 transmits the combined permuted list and object identifier to the first encryption slice service referenced in the permuted list. Thus, encryption slice 1 service 403 requests the slice data from the slice 1 database 404 which is sent to the encryption slice 1 service 403 via message 432. Upon receipt of the message 432, the encryption slice 1 service 403 places the received data into the correct element locations for the original data according to the key received from the encryption gateway service 402. The encryption slice 1 service 403 then transmits the partially completed object data 433 to the next encryption slice service 405, which repeats the retrieval steps for the next slice elements. Upon processing the final slice at encryption slice N service 407, the retrieved object is transmitted to the encryption gateway service 402, which then transmits the retrieved object 438 to the application 401.

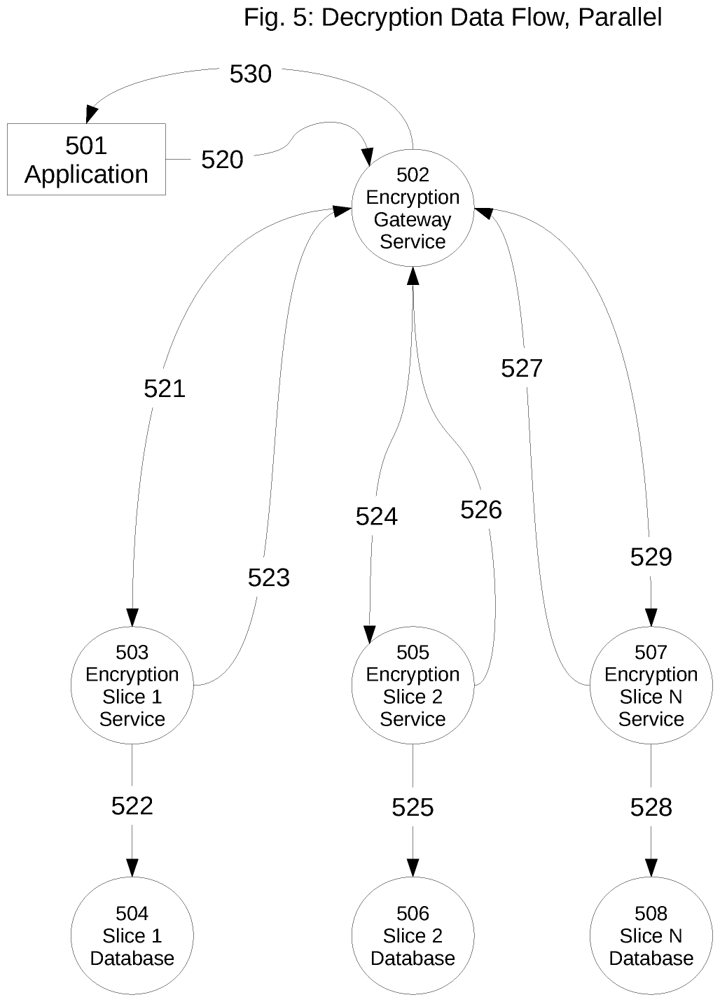

FIG. 5 is an example of the of an embodiment of the invention performing the decryption function utilizing a parallel method of data movement. In the embodiment illustrated, an application 501 transmits the object identifier and encryption key 520 to an encryption gateway service 502. The encryption gateway service 502 utilizes the key to permute the list of available encryption slice services (503,505,507), transmitting the object identifier and key to each encryption slice service according to the list of numbers in the permuted list. In the illustrated embodiment, the key has been permuted such that the slices are in the same order as the database numbering. The encryption gateway services 502 transmits the permuted list and object identifier simultaneously to all encryption slice services (503,505,507) via messages 521,524,529. Each encryption slice service (503,505,507) then retrieves the slice (522,525,528) from its respective database (504,506,508). Each encryption slice service (503,505,507) then responds with its partial piece of the original object data by sending a status message and partial object data (523,526,527) which is transmitted to the encryption gateway service 502. The encryption gateway services 502 then joins the slices together to re-create the original object data. The original object data 530 to the application 501.

Those skilled in the art will appreciate that many modifications to the exemplary embodiments are possible without departing from the scope of the invention. In addition, it is possible to use some of the features of the embodiments described without the corresponding use of the other features. Accordingly, the foregoing description of the exemplary embodiments is provided for the purpose of illustrating the principle of the invention, and not in limitation thereof, since the scope of the invention is defined solely be the appended claims.

An encryption system utilizes combined transform and distribution encryption methods where stored objects are separated into fragments, the fragments arranged according to a permutation defined by an encryption key that represents a very large integer, and the fragments stored in one or more databases on a network. Successful retrieval of objects requires an object identifier and the correct permutation of fragments. Additional components include a facility for searching and sharing the content of encrypted objects.

### TECHNICAL FIELD OF THE INVENTION

The present invention relates generally to data distributed within a network and more particularly to a method and system for encrypting, cataloging, and retrieving files distributed across devices in a network.

### BACKGROUND OF INVENTION

Traditional encrypted storage relies on a series of data transformations which reversibly increase entropy in a message. Reversing that entropy without encryption keys requires enormous amounts of computing time, creating what is known as a “trapdoor” function. The most popular types of encryption current rely on the difficulty of processing very large numbers; it is possible to determine the original content given enough computing power (such as using a quantum computing system), poorly structured encryption algorithms, or improperly generated encryption keys. The threat is further increased by new discoveries in the characteristics of numbers which are at the core of current public key cryptography systems.

Encryption methods are typically described as transform or distribution methods, where a distribution method rearranges the original data in such a way to obscure its content, while a transform method alters the data according to a key value applied through an algorithm to the original data. In most encryption implementations, a transform method is used due to its applicability to both temporary data (such as network packets) and encrypted file storage. However, transform methods are unable to take advantage of distributed computing which provides far stronger encryption while encompassing all aspects of managing the storage, retrieval and cataloging of encrypted objects. The encryption technology described here is able to use these advantages while reducing the chances of inadvertent disclosure of data, a problem which has plagued organizations that use cloud (distributed) storage systems, leading to massive financial losses and damage to individuals.

In contrast, the encryption technology described in this document is a combined transform and distribution encryption method which uses a series of databases potentially distributed across many devices, each device containing a transformed subset (“slice”) of the original object data. Objects, typically files, are stored within this system such that each object has a unique identifier within the system and an encryption key, and each object is broken into some number of slices prior to storage. When an object is received by the system, it is first transformed by an algorithm to increase entropy, eliminating the appearance of any detectable pattern in the original data. Once transformed, the object is separated into slices, and each slice is stored on a specific device based on the encryption key. To retrieve data stored within the system, the unique identifier and encryption key must be provided in a request sent to a well-defined interface to the set of devices which store a desired object.

The encryption keys consist of extremely large integers which represent a permutation of the original data. A slice of the original data contains every Nth byte of the original data, where N is the number of slices to be permuted. Once a slice is created, it is then stored on a specific device based on a permuted list of N devices. The key values themselves do not have any specific characteristics (they are not prime numbers or some other particular subset of the set of integers) aside from enumerating a specific permutation out of the available permutations. However, unique to this encryption method, the range of the key values can be variable, and the strength of the range is indicated by a “degree”. A preferred implementation of the encryption would use a 256-degree system at minimum, which is nearly unbreakable through brute-force or guessing methods as the set of possible key values is approximately 8.578177753×10⁵⁰⁶ in size.

A unique feature of the described system is the ability to catalog and describe encrypted data stored in the cloud system using a faceted search engine. Facets describe content using a series of name-value pairs, where both the name and value themselves can be encrypted and where value change history is retained (versioning). Search results can be filtered or altered based on the same concept of rules and roles mentioned previously. Using the facets, it is also possible to define subsets of stored files that may be shared between organizations without divulging content or exposing the existence of other files stored in the system, thus creating a content sharing system that guarantees privacy to all parties while still permitting data sharing.

The described encryption method is also an ideal solution to the problem of storing large amounts of data within a distributed ledger system such as blockchain implementations. Typically, the blockchain ledger is composed of very small transaction records, making it impractical to store documents or media files within the system. This requires the use of a secondary storage system which may or may not be secure. Not only does the described encryption system solve the secure storage problem, but the faceting system allows for the storage of immutable data such as hash values or other information used to verify the authenticity of stored files.

### SUMMARY OF INVENTION

The present invention encrypts an object by separating it into a series of fragments, called “slices”, each of which contains a subset of the original data, where slices are extracted from the original object data in a particular order, defined by an encryption key which is a very large integer representing one permutation out of a set of N permutations. Each fragment is stored in a database, where the database selected is also defined by an encryption key. To retrieve the stored object, the identifier for the object is supplied along with one or more keys. The slices are then retrieved from their respective databases according to a key and reassembled according to a key. Finally, the reconstituted slices are recombined into an object according to the keys and sent to the requester. The core concept of the system is the rearrangement of source data into distributed slices that must be recombined in the correct order (given by the key) to be decrypted.

According to another aspect of the preferred embodiment, each object stored is assigned a unique identifier, and at least one encryption key. The unique identifier is used by a requester to retrieve a specific object, and it is used by the databases to identify slices of the data from an object.

According to another aspect of the invention, objects to be stored are pre-processed by a data transform function which diffuses bits in the original data in such a way that no pattern may be observed within the encoded data. Once the transform function is performed, the data is separated into slices and stored in databases according to the permutation indicated by the key.

According to a further aspect of the invention, slices are extracted from the object to be stored using a data selection function which uses a predictable pattern to indicate which source data is to be stored in a given slice database. The form of the data selection function is variable.

According to another aspect of the invention, slices may be further processed by a transform function, and then they are stored in slice databases along with the unique identifier.

According to a further aspect of the invention, retrieval is performed by using the unique identifier for the object stored to retrieve the correct slices from slice databases, optionally pre-processing slice data with the reverse of a previous transform function, and then using the encryption key (the permutation number) to correctly re-assemble the slices into the original order to form the object. Once re-assembled, the object may have the reverse of a previous pre-storage transform function performed, after which the object has been restored.

According to another aspect of the invention, transform and transposition function components and inputs may be distributed across many machines. This can be used to provide specific entry points for storage and retrieval operations (possibly determined by the encryption key) and provide for mechanisms such as time locks or other special rules that govern access to the stored objects.

### DESCRIPTION OF DRAWINGS

FIG. 1 is an example of how source object data is distributed to slices in a preferred embodiment with the use of an encryption key

FIG. 2 describes the data flow of the encryption process using a serial storage methodology according to various embodiments within.

FIG. 3 describes the data flow of the encryption process using a parallel storage methodology according to various embodiments within.

FIG. 4 describes the data flow of the decryption process using a serial storage methodology according to various embodiments within.

FIG. 5 describes the data flow of the decryption process using a parallel storage methodology according to various embodiments within.

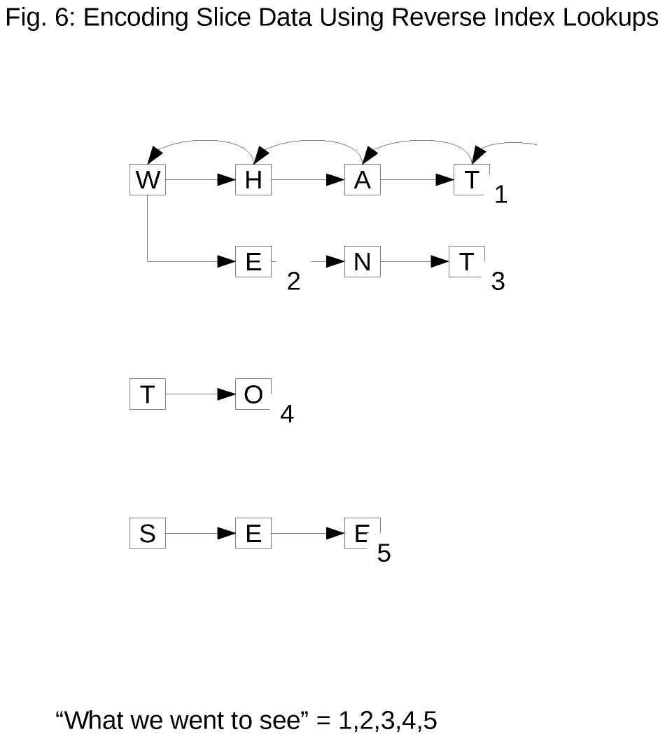

FIG. 6 describes the encoding slice data using reverse index lookups according to various embodiments within.

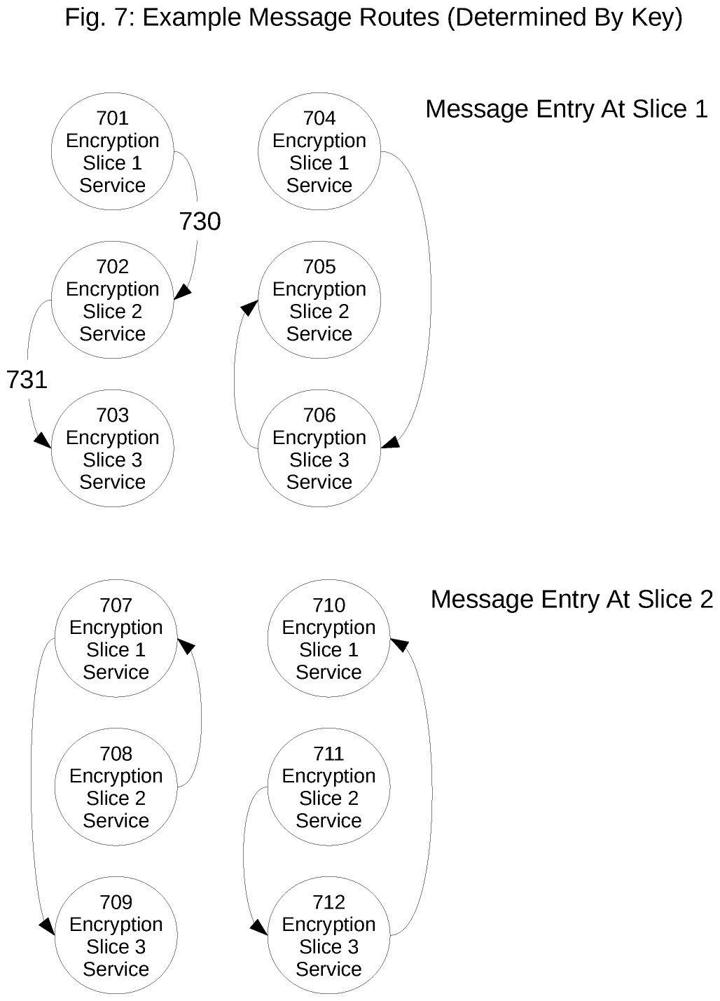

FIG. 7 describes the example message routes (determined by key) according to various embodiments within.

### DETAILED DESCRIPTION OF INVENTION

The terminology used herein is for the purpose of describing particular embodiments only and is not intended to be limiting of the invention. As used herein, the term “and/or” includes any and all combinations of one or more of the associated listed items. As used herein, the singular forms ‘a’, ‘an’, and ‘the’ are intended to include the plural forms as well as the singular forms, unless the context clearly indicates otherwise.

It will be further understood that the terms ‘comprises’ and/or ‘comprising’ when used in this specification, specify the presence of stated features, steps, operations, elements, and/or components, but do not preclude the presence or addition of one or more other features, steps, operations, elements, components, and/or groups thereof. Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below. The present invention will now be described by referencing the appended figures representing preferred embodiments.

FIG. 1 is used to illustrate an example of the fundamental transposition of object data into slice databases as described in the invention summary. In preferred embodiments, the original object data 101 is arranged in a list of elements, where each element represents some fragment of the original object data, such as bytes (8-bit elements). Given a slice factor of three as shown in the figure, hereafter referred to as the variable “N”, the original source data elements are separated into three-element selections such that every Nth element of the list is transmitted via message to a slice database. According to the preferred embodiment, the object data 101 is stored in a slice database according to a value found in the key lookup table 105. In a preferred embodiment, the key lookup table 105 consists of a sequence of values referencing slice databases, and the encryption key itself is the permutation number of the sequence of values. Thus, the value “12” in the original data 101 uses the value of “2” in the key lookup table 105 to store the original data element in slice 2 database 103 via pointer 107. As described previously, this example has a slice factor of three, therefore the key value list 105 consists of three elements repeated as many times as required to store the original data 101. Thus, the second element of the key value list 105 contains a value of “1”, which references slice 1 database 102, and the third element of the key value list 105 contains a value of “2”, which references slice 2 database 103.

FIG. 2 is an example of the of an embodiment of the invention performing the encryption function utilizing a serial (sequential) method of data movement. In the embodiment illustrated, an application 201 transmits a combined object, object identifier and encryption key 230 to an encryption gateway service 202. The encryption gateway service 202 utilizes the key to permute the list of available encryption slice services (203,205,207), transmitting the object data to each encryption slice service according to the list of numbers in the permuted list. In the illustrated embodiment, the key has been permuted such that the slices are in the same order as the database numbering. The encryption gateway services 202 transmits the combined permuted list and object data to the first encryption slice service referenced in the permuted list. Thus, encryption slice 1 service 203 extracts every Nth element of data from the received object data where N is the number of slices, storing this data 232 into the slice 1 database 204. Subsequently, the original object data and permuted list are transmitted 233 to the next encryption slice service, encryption slice 2 service 205. As with the first encryption slice service 203, encryption slice 2 service 205 extracts every Nth element of data from the received object data, storing this data 234 into the slice 1 database 206. Finally, the original object data and permuted list are transmitted 235 to the next encryption slice service, encryption slice 3 service 207. As with the first encryption slice service 203, encryption slice 3 service 207 extracts every Nth element of data from the received object data, storing this data 236 into the slice 1 database 208. Upon completion of the storage of the object data by the final encryption slice service 207, a status message 237 indicating storage and any other metadata is transmitted to the encryption gateway services 202, which then also transmits a status message 238 to the application 201 to complete the operation.

FIG. 3 is an example of the of an embodiment of the invention performing the encryption function utilizing a parallel method of data movement. In the embodiment illustrated, an application 301 transmits the original object data, object identifier and encryption key 320 to an encryption gateway service 302. The encryption gateway service 202 utilizes the key to permute the list of available encryption slice services (303,305,307), transmitting the object data to each encryption slice service according to the list of numbers in the permuted list. In the illustrated embodiment, the key has been permuted such that the slices are in the same order as the database numbering. The encryption gateway services 302 transmits the combined permuted list and every Nth element of the original object data simultaneously to all encryption slice services (303,305,307) via messages 321,324,329. Each encryption slice service (303,305,307) then stores the slice (322,325,328) into its respective database (304,306,308). Each encryption slice service (303,305,307) then responds with a status message (323,326,327) which is transmitted to the encryption gateway service 302. The encryption gateway services 302 then responds by transmitting a status message 320 to the application 301.

FIG. 4 is an example of the of an embodiment of the invention performing the decryption function utilizing a serial (sequential) method of data movement. In the embodiment illustrated, an application 401 transmits a combined object identifier and encryption key 430 to an encryption gateway service 402. The encryption gateway service 402 utilizes the key to permute the list of available encryption slice services (403,405,407), requesting the object data from each encryption slice service according to the list of numbers in the permuted list. In the illustrated embodiment, the key has been permuted such that the slices are in the same order as the database numbering. The encryption gateway service 402 transmits the combined permuted list and object identifier to the first encryption slice service referenced in the permuted list. Thus, encryption slice 1 service 403 requests the slice data from the slice 1 database 404 which is sent to the encryption slice 1 service 403 via message 432. Upon receipt of the message 432, the encryption slice 1 service 403 places the received data into the correct element locations for the original data according to the key received from the encryption gateway service 402. The encryption slice 1 service 403 then transmits the partially completed object data 433 to the next encryption slice service 405, which repeats the retrieval steps for the next slice elements. Upon processing the final slice at encryption slice N service 407, the retrieved object is transmitted to the encryption gateway service 402, which then transmits the retrieved object 438 to the application 401.

FIG. 5 is an example of the of an embodiment of the invention performing the decryption function utilizing a parallel method of data movement. In the embodiment illustrated, an application 501 transmits the object identifier and encryption key 520 to an encryption gateway service 502. The encryption gateway service 502 utilizes the key to permute the list of available encryption slice services (503,505,507), transmitting the object identifier and key to each encryption slice service according to the list of numbers in the permuted list. In the illustrated embodiment, the key has been permuted such that the slices are in the same order as the database numbering. The encryption gateway services 502 transmits the permuted list and object identifier simultaneously to all encryption slice services (503,505,507) via messages 521,524,529. Each encryption slice service (503,505,507) then retrieves the slice (522,525,528) from its respective database (504,506,508). Each encryption slice service (503,505,507) then responds with its partial piece of the original object data by sending a status message and partial object data (523,526,527) which is transmitted to the encryption gateway service 502. The encryption gateway services 502 then joins the slices together to re-create the original object data. The original object data 530 to the application 501.

Those skilled in the art will appreciate that many modifications to the exemplary embodiments are possible without departing from the scope of the invention. In addition, it is possible to use some of the features of the embodiments described without the corresponding use of the other features. Accordingly, the foregoing description of the exemplary embodiments is provided for the purpose of illustrating the principle of the invention, and not in limitation thereof, since the scope of the invention is defined solely be the appended claims.

What is claimed is:

1. A combined transformation and distribution encryption method for processing data in a series of databases across a set of devices having a defined interface, each device containing a transformed subset of original object data, and each object having a unique identifier and an encryption key, comprising the steps of:
transforming the object via an algorithm;
fragmenting each object into a plurality of subsets;
separating the transformed object subsets according to an encryption algorithm; and
storing each such transformed subset in a specific device and in a selected sequence based on the encryption key.

2. The combined transformation and distribution encryption method for processing data of claim 1, further comprising the step of retrieving the data stored within the system by sending the unique identifier and encryption key in a request to the defined interface of the set of devices which have stored the desired object.

3. The combined transformation and distribution encryption method for processing data of claim 1 wherein transforming the object by an algorithm increases entropy.

4. The combined transformation and distribution encryption method for processing data of claim 1 wherein transforming the object by an algorithm eliminates the appearance of any detectable pattern in the original data.

5. The combined transformation and distribution encryption method for processing data of claim 1 wherein the transformed subsets comprise slices of the data.

6. The combined transformation and distribution encryption method for processing data of claim 1 wherein the object comprises a data file.

7. The combined transformation and distribution encryption method for processing data of claim 1 wherein the encryption keys comprise large integers which represent a permutation of the original data.

8. The combined transformation and distribution encryption method for processing data of claim 1 wherein the transformed subset of the original data contains every Nth byte of the original data, where N is the number of items to be permuted.

9. The combined transformation and distribution encryption method for processing data of claim 1 wherein the created subset of data is stored on a specific device based on a permuted list of N devices.

10. The combined transformation and distribution encryption method for processing data of claim 1 wherein the encryption key values do not have any specific characteristics.

11. The combined transformation and distribution encryption method for processing data of claim 1 wherein the encryption key values enumerate a specific permutation selected from available permutations.

12. The combined transformation and distribution encryption method for processing data of claim 1 wherein the range of the encryption key values is variable.

13. The combined transformation and distribution encryption method for processing data of claim 1 wherein the strength of the range of the encryption key values is indicated by a defined degree.

14. The combined transformation and distribution encryption method for processing data of claim 1 wherein the strength of the range of the encryption key values is a 256-degree system.

15. The combined transformation and distribution encryption method for processing data of claim 1 further comprising cataloging and describing the encrypted data stored in the cloud system utilizing a faceted search engine.

16. The combined transformation and distribution encryption method for processing data of claim 1 further comprising describing the data content via the faceted search engine utilizing a series of name-value pairs, wherein both the name and value are encrypted and wherein value change history is retained via versioning.

17. The combined transformation and distribution encryption method for processing data of claim 1 further comprising filtering the search results based on defined rules.

18. The combined transformation and distribution encryption method for processing data of claim 1 further comprising altering the search results based on defined rules.

19. A combined transformation and distribution encryption method for processing data in a series of databases across a set of devices comprising the steps of:
separating a data object into a series of data fragments via extrac-tion from the original object data in an order defined by an encryption key; and
storing each such data fragment in a selected database defined by an encryption key;
supplying the identifier for the object along with one or more encryption keys;
retrieving the data fragments from their respective databases according to definitions identified by the encryption key;
reassembling the data fragments according to definitions identified by the encryption key;
recombining the reconstituted data fragments into an object according to the keys; and
sending the recombined object to the requester.

20. The combined transformation and distribution encryption method for processing data in a series of databases across a set of devices of claim 19, wherein the encryption key comprises a large integer representing one permutation out of a set of N permutations.

21. The combined transformation and distribution encryption method for processing data in a series of databases across a set of devices comprising the steps of:
separating data into data fragments, the size and contents of which are defined by an encryption key;
defining an encryption storage sequence according to an encryption key;
storing each item of fragmented data in the encryption storage sequence in a database file;
retrieving the fragmented data from the respective encrypted database files; and
recombining the data fragments of source data into the original sequence.

22. The combined transformation and distribution encryption method for processing data in a series of databases across a set of devices of claim 21 wherein defining the encryption storage sequence comprises selecting the sequence of the data fragments to be stored.

23. The combined transformation and distribution encryption method for processing data in a series of databases across a set of devices of claim 21 wherein defining the encryption storage sequence comprises defining the sequence of the database files for use in storing the data fragments.

24. The combined transformation and distribution encryption method for processing data in a series of databases across a set of devices of claim 21, wherein the encryption key comprises a large integer representing one permutation out of a set of N permutations.

25. The combined transformation and distribution encryption method for processing data in a series of databases across a set of devices of claim 21 wherein each object stored is assigned a unique identifier and at least one encryption key.

26. The combined transformation and distribution encryption method for processing data in a series of databases across a set of devices of claim 21 wherein the unique identifier is used by a requester to retrieve a specific object, and it is used by the databases to identify data fragments.

27. The combined transformation and distribution encryption method for processing data in a series of databases across a set of devices of claim 21 wherein the objects to be stored are pre-processed prior to fragmentation by a data transform function, whereby bits in the original data are diffused in such a way that no pattern may be observed within the encoded data.

28. The combined transformation and distribution encryption method for processing data in a series of databases across a set of devices of claim 21 wherein after fragmentation the data fragments are additionally transformed prior to storage.
